(19) United States
(12) Patent Application Publication
(10) Pub. No.: US 2025/0172347 A1
(43) Pub. Date: May 29, 2025

(54) HIGH-EFFICIENCY DESALINATION

(71) Applicant: SYLVAN SOURCE, INC., San Carlos, CA (US)

(72) Inventors: Eugene Thiers, San Mateo, CA (US); Gary Lum, San Jose, CA (US)

(21) Appl. No.: 19/024,837

(22) Filed: Jan. 16, 2025

Related U.S. Application Data
(62) Division of application No. 17/315,327, filed on May 9, 2021.
Application No. 17/315,327 is a continuation of application No. 15/554,824, filed on Aug. 31, 2017, now abandoned.
(60) Provisional application No. 62/126,991, filed on Mar. 2, 2015.

(51) Int. Cl. F28D 15/02; B01D 1/00; B01D 3/00; B01D 3/06; C02F 1/08; C02F 1/12; C02F 1/14; C02F 1/44; C02F 1/469; C02F 103/08; F28D 5/02; F28D 21/00; F28F 1/10

(52) U.S. Cl. CPC F28D 15/0266; B01D 1/0011; B01D 3/007; B01D 3/065; C02F 1/08; C02F 1/12; C02F 1/14; C02F 1/441; C02F 1/445; F28D 5/02; F28D 15/02; F28D 15/0275; F28F 1/10; C02F 1/447; C02F 1/4693; C02F 2103/08; F28D 2021/0061; Y02A 20/124; Y02W 10/37

(57) ABSTRACT

Embodiments of the invention provide systems and methods for heat transfer systems at temperatures in the range of 20 C to 800 C. The systems consist of heat pipes configured such that they fit inside conventional heat exchangers, and more effectively transfer or recover heat from hot fluids, and that operate without user intervention over long periods of time.

### CROSS-REFERENCE TO RELATED APPLICATION

This application claims priority to U.S. Provisional Patent Application No. 62/126,991, filed Mar. 2, 2015; the entire disclosure thereof is incorporated herein by reference.

This invention relates to the field of desalination of saline solutions, from highly concentrated sea water to brackish water by conventional technologies that range from reverse osmosis and forward osmosis to thermal distillation systems, membrane distillation systems, electro-oxidation, and dialysis. In particular, embodiments of the invention relate to the use of heat pipes, pulsed heat pipes, advanced heat pipes and thermosiphons for heat transfer and recovery, thereby achieving significant advantages in overall energy efficiency.

### BACKGROUND

Two groups of technology predominate in water desalination applications: one based on osmosis phenomena and one on distillation phenomena under partial vacuum. Under the first group, reverse osmosis (RO) is dominant in terms of existing industrial plants, although forward osmosis (FO) systems are receiving increasing attention notwithstanding the fact that the technology is commercially less developed. In the case of distillation systems, multiple effect distillation (MED) appears to provide superior energy efficiency over multi-flash systems (MSF), particularly in combination with vapor compression that reduce energy consumption further.

However, osmosis-based systems provide increased efficiencies when employed at higher than ambient operating temperature. Thus, it is advantageous to provide efficient heat transfer technology to such systems in order to increase their performance. Since most desalination plants operate in areas with significant waste heat sources that are readily available, many such plants make use of heat exchangers to re-utilize such waste heat sources. However, heat exchangers operate on the basis of thermal conductivity, in which a hot fluid transfers heat energy across a metal plate to a lower-temperature fluid. Accordingly, conventional heat exchangers are characterized by requiring substantial surface area and comparatively large temperature differentials between the hot and cool fluids of many degrees. There is a need for improved heat transfer devices that can operate with lower temperature differentials and that make use of waste heat sources for desalination.

### SUMMARY

Embodiments of the present invention provide an improved method for transferring heat efficiently in a number of industrial applications, including desalination of saline aqueous solutions using either osmosis-based technologies, thermal distillation systems, membrane distillation systems, electro-oxidation, or electro-dialysis systems. The present invention provides embodiments that replace conventional heat exchangers, including thin film evaporators, by advanced heat pipes that are characterized by very thin walls of less than 1-2 millimeters and superior wick materials that provide for minimal temperature differentials and uncommonly high heat transfer coefficients.

Some embodiments of the invention provide a heat management system including heat pipes, thermosiphons, or advanced heat pipes that replaces conventional heat exchangers, including thin-film evaporators, that effect heat transfer in distillation systems that operate above ambient temperature and that can transfer heat at temperatures in the range of 20 C to 800 C from a variety of heat sources.

Some embodiments of the invention provide a heat management system in which the distillation system can be MED, MSF, vapor compression, membrane distillation, electro-oxidation, or electro-dialysis systems, or the like.

Some embodiments of the invention provide a heat management system in which heat pipes, thermosiphons, or advanced heat pipes can replace conventional heat exchangers in forward and reverse osmosis systems, or the like.

Conventional heat pipes are normally manufactured from commercial metal tubes that have wall thicknesses commonly in the range of 1/16″ to ¼″. Advanced heat pipes rely on metal screen scaffolds for mechanical integrity and can have wall thicknesses of less than 1-2 millimeters, and occasionally as low as a fraction of a millimeter, thus greatly enhancing the thermal conductivity of the encapsulating material. The heat pipes can have a wall thickness of about 0.1, 0.2, 0.3., 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, millimeters or more. Likewise, conventional wicks can include grooves, metal screens, and sintered metal particles with good open porosity. Metal sintered wicks can include microspheres of metal (e.g., copper, steel. titanium, or various metal alloys, or the like) that are a few microns or, in special cases, submicron in size and that have been sintered together. The microspheres of metal can be about 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1. 2.2, 2.3, 2.4, 2.5. 2.6, 2.7, 2.8, 2.9, 3.0, 3.1, 3.2, 3.3, 3.5, 4.0, 4.5, 5.0 microns or more. While such wick materials can assist in the phase change of the internal working fluid, they can also represent a thermal barrier to heat transfer. Superior wick materials can include grooves, screens, and sintered metals of smaller pore size, of the order of 60 nanometers to several hundreds of nanometers (for example, about 60, 75, 100, 125, 150, 175, 200, 225, 250, 275, 300, 325, 350, 375, 400 nanometers, or more), and thinner overall thickness, of the order of several microns (for example, about 1, 1.2, 1.4, 1.6. 1.8. 2.0. 2.2. 2.4, 2.6, 2.8, 3.0, 3.2. 3.4. 3.6. 3.8, 4.0 microns. or more). Alternatively, superior wick materials can include porous materials that can be placed axially along the center of the heat pipe, so as not to contribute to a barrier to heat transfer.

### BRIEF DESCRIPTION OF THE DRAWINGS

FIG. 1A illustrates a simple heat transfer device configuration that uses a heat pipe; FIG. 1B shows a heat transfer device that uses a heat pipe and has a vertical configuration; Figure 1C shows a heat transfer device that uses multiple heat pipes and has a horizontal configuration; FIG. 1D shows a heat transfer device that uses multiple heat pipes and has another orientation; FIG. 1E shows a heat transfer device that uses multiple heat pipes and has yet another orientation; Figure IF shows a heat exchanger in which a hot fluid can enter the heat exchanger and transfer heat across a metal plate.

FIG. 2A illustrates a conventional stage in a multiple effect distillation system; FIG. 2B illustrates a stage in a multiple effect distillation system that uses heat pipes.

FIG. 3A illustrates a forward-osmosis system in which saline water enters a pre-heating vessel where heat pipes provide heat from a heat source; FIG. 3B illustrates a forward-osmosis system in which heat pipes are used to provide heat energy for separating a draw solution from product water.

FIG. 4 illustrates a reverse-osmosis diagram

FIG. 5 illustrates a multiple-effect distillation system

### DETAILED DESCRIPTION

Embodiments of the invention are disclosed herein, in some cases in exemplary form or by reference to one or more Figures. However, any such disclosure of a particular embodiment is exemplary only. and is not necessarily indicative of the full scope of the invention.

Thermal distillation systems, such as MED, use horizontal thin film evaporating tubes to transfer and re-use thermal energy. However, such systems suffer from several operating problems such as dry-spots that cause local crystallization of salts, thermal inefficiencies caused by the condensation of liquid inside the horizontal tube, and temperature losses caused by the progressive vapor condensation inside the horizontal tube. There is a need for heat transfer devices that overcome these problems.

Membrane distillation systems rely on the increase in vapor pressure caused by the curvature of very small menisci at the liquid/vapor interface. Higher temperatures in the feedwater liquid naturally can increase the vapor pressure at the interface, thus rendering the system more thermally efficient. While there can be multiple ways of increasing the temperature of a system, heat pipes can be most efficient at transferring heat energy and, thus, can be used to increase the overall efficiency of such distillation systems.

Electro-oxidation systems operate by oxidizing dissolved contaminants by means of charged electrodes. Again, higher temperatures in the liquid phase can increase the kinetic energy of molecules in the liquid, thus can improve the electrical performance of the electrodes and heat pipes can be an optimal way of providing the additional heat energy required.

In dialysis, particularly in electro-dialysis, the diffusion of impurities across a semi-permeable membrane is enhanced by an electromagnetic potential. As in other liquid systems, higher temperature can markedly increase molecular and ionic diffusion. Heat pipes can be well suited to provide the necessary heat energy.

An important advantage of the present invention described herein is the heat transfer mechanism by using heat pipes. As described in the present application, heat pipes can provide a means of transferring heat that is near thermodynamically reversible, that is, a system that transfers enthalpy with almost no losses in efficiency.

In some embodiments, the system for heat transfer, embodiments of which are disclosed herein, can be combined with other systems and devices to provide further beneficial features. For example, the system can be used in conjunction with any of the devices or methods disclosed in U.S. Provisional Patent Application No. 60/676,870, entitled SOLAR ALIGNMENT DEVICE, filed May 2, 2005; U.S. Provisional Patent Application No. 60/697,104, entitled VISUAL WATER FLOW INDICATOR, filed Jul. 6, 2005; U.S. Provisional Patent Application No. 60/697,106, entitled APPARATUS FOR RESTORING THE MINERAL CONTENT OF DRINKING WATER, filed Jul. 6, 2005; U.S. Provisional Patent Application No. 60/697,107, entitled IMPROVED CYCLONE DEMISTER, filed Jul. 6, 2005; PCT Application No. US2004/039993, entitled AN IMPROVED SELF-CLEANING WATER PROCESSING APPARATUS, filed Dec. 1, 2004; PCT Application No. US2004/039991, entitled FULLY AUTOMATED WATER PROCESSING CONTROL SYSTEM, filed Dec. 1, 2004; PCT Application No. US2006/040103, entitled WATER PURIFICATION SYSTEM, filed Oct. 13, 2006; U.S. patent application Ser. No. 12/281,608, entitled CONTAMINANT PREVENTION, filed Sep. 3, 2008; PCT Application No. US2008/03744, entitled WATER PURIFICATION SYSTEM, filed Mar. 21, 2008; U.S. Provisional Patent Application No. 60/526,580, entitled SELF-CLEANING WATER PROCESSING APPARATUS, filed Dec. 2, 2003; U.S. Provisional Patent Application No. 61/532,766 of Sylvan Source, Inc., entitled INDUSTRIAL WATER PURIFICATION AND DESALINATION, filed Sep. 9, 2011; PCT Application No. US2013/51730, entitled EFFECTIVE DEWATERING FOR BIOFUEL PRODUCTION, filed on Jul. 23, 2013; U.S. Provisional Patent Application No. 62/041,556, entitled ENERGY EFFICIENT EOR, filed on Aug. 25, 2014; U.S. Provisional Patent Application No. 62/087,122, entitled ENERGY EFFICIENT WATER PURIFICATION AND DESALINATION, filed on Dec. 3, 2014; and U.S. Pat. No. 8,771,477, entitled LARGE-SCALE WATER PURIFICATION AND DESALINATION, filed on Jun. 1, 2011 each of the foregoing applications and patent is hereby incorporated by reference in its entirety.

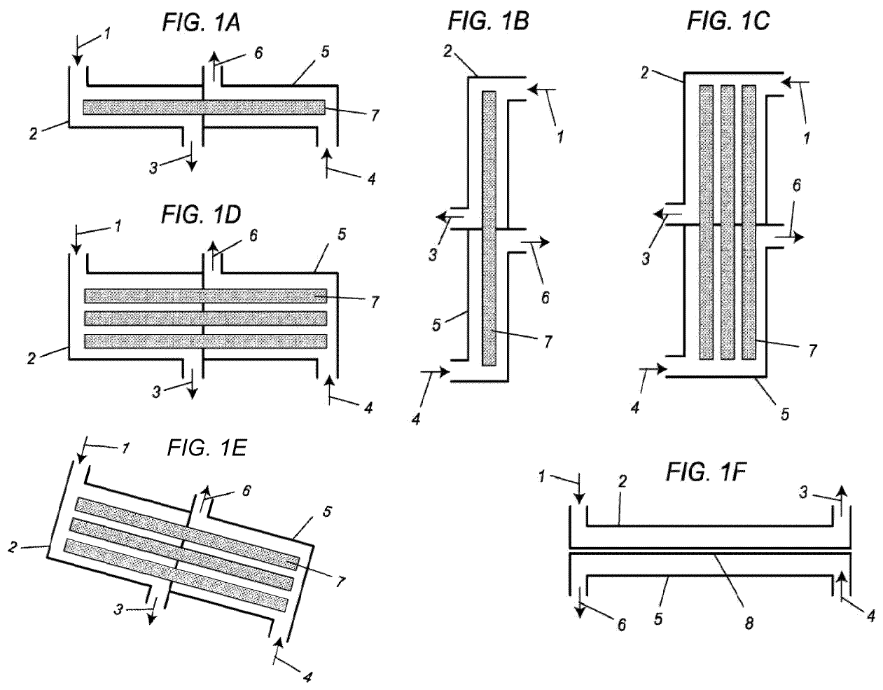

FIGS. 1A-IF show several examples of heat transfer devices that use heat pipes to replace conventional heat exchangers. FIG. 1F illustrates a conventional heat exchanger in which a hot fluid (1) enters the heat exchanger (2) and transfers heat across a metal plate (8) to a cooler fluid (4) that also enters the heat exchanger in the opposite direction. As a result of thermal conduction across the metal plate (8), heat flows from the hot fluid (1) into the cooler fluid (4) and, as a result, the hot fluid (1) loses temperature as it exits the device at point (3), while the cooler fluid (4) gains a higher temperature and exits at point (6). The total amount of heat transferred is directly proportional to the surface area of the metal plate (8), inversely proportional to the thickness of that metal plate, directly proportional to the heat conductivity of the metal plate material (8), and directly proportional to the temperature difference between the hot and cool fluids.

A common problem with any thermal transfer based on thermal conductivity is that the rate of heat flow across a thermally conductive material is rather slow, which requires fairly large surface areas, which directly influences the cost of a device. Another problem with conventional thermal transfer that relies on conductivity is that as a fluid transfers heat it necessarily cools down, thereby reducing the temperature differential across the material that transfers heat. Thus, both the surface area and the temperature differential which directly affect heat transfer are influenced by the mechanism that relies solely on thermal conductivity. In contrast, a heat pipe transfers heat primarily through phase change and the mass transfer of the working fluid that has been volatilized. As a result, conventional heat pipes can exhibit thermal conductivities of about one thousand times greater than silver metal (“Heat Pipes or Heat Exchangers”. Ivan Catton, UCLA, Sep. 12, 2014), and advanced heat pipes can have conductivities of nearly 30,000 time that of silver (“Thermal Property Analysis of the Qu Supertube”. Michael McKubre, SRI International, Jul. 1999).

In addition, since heat exchangers intentionally establish direct contact between fluids and metal pieces, they can become fouled, whereas heat pipes, being sealed tubes, can protect the inner working fluid from scaling up or fouling, and their outer surfaces can be smooth and easy to clean.

FIG. 1A illustrates a simple configuration that replaces a heat exchanger with a heat pipe. In this figure, hot fluid (1) enters a heat transfer vessel (2) that is divided into two halves. As the hot fluid (1) enters, it transfers heat to a heat pipe (7), thereby becoming cooler and ultimately exiting the system at point (3). The heat pipe (7) transfers essentially all this heat at nearly the speed of sound to the other half of the heat transfer vessel (5) where cooler fluid (4) enters, gains heat from the heat pipe (7), and exits at a significantly higher temperature at point (6).

FIG. 1A graphically illustrates several fundamental advantages of the heat pipe when compared to a conventional heat exchanger. First, assuming similar dimensions for FIGS. 1A and IF, the heat transfer surface for thermal conductivity can be approximately 3.14 (the value of Pi) times higher for the heat pipe than for the heat exchanger because the diameter of the heat pipe can be very close to the heat transfer vessel (2), irrespective of whether that vessel is cylindrical or rectangular. Therefore, the thermal conductivity portion of heat transfer can be considerably better for heat pipes. Second, because conductivity is a minor contributor to overall thermal transfer in heat pipes; the primary mechanism can be based on phase change as the inner working fluid evaporates under partial vacuum and travels nearly instantaneously through the axis of the heat pipe. Third, because the transfer of heat through the heat pipe is so fast, the temperature differential between the hot and cold sides of the heat pipe is minimized; typically, commercial heat pipes can exhibit temperature differences of a few degrees centigrade, whereas commercial heat exchangers can range from several to tens of degrees centigrade, or more. Fourth, because on the colder side of the heat pipe, condensation of the working fluid delivers the heat of condensation, which is the same as the heat of evaporation; so except for wall losses that are relatively insignificant given the minimal separation between the two halves of the heat transfer vessel, the heat transfer can be nearly adiabatic. And fifth, because after condensation of the working fluid, heat transfer can again occur by thermal conductivity and the greater surface area of the heat pipe can provide another advantage.

FIG. 1B shows a vertical instead of a horizontal configuration for heat transfer using heat pipes, and illustrates another major advantage of this type of technology, the advantage of using capillary transfer of the working fluid inside the heat pipe, which can allow the device to operate in any direction and in any orientation. The inner capillary (called a wick) can include either sintered microscopic spheres or screens that allow the working fluid to travel against gravity from the point of condensation to the point of evaporation, regardless of orientation. Microscopic spheres, with individual sizes in the range of several microns or in the submicron range can be commercially available in various metals and alloys. Microscopic spheres can be spread on the inner surface of a metal tube and sintered together, so they can provide inter-connected porosity. Metal screens can be in various sizes (normally denoted by mesh size, Mesh is a standard unit defined as the number of wired squares in a square screen per unit linear inch, equivalent to the number of holes in a linear inch). Metal screens that function as internal wicks can have sizes of 60 to 300 mesh. The mesh size can be about 60, 100, 150, 200, 250, 300 mesh, or more. FIGS. 1C, 1D, and 1E show multiple heat pipes instead of a single one, and illustrate that the surface area advantage for thermal conductivity in heat pipes can be enhanced by simply using multiple heat pipes in any orientation.

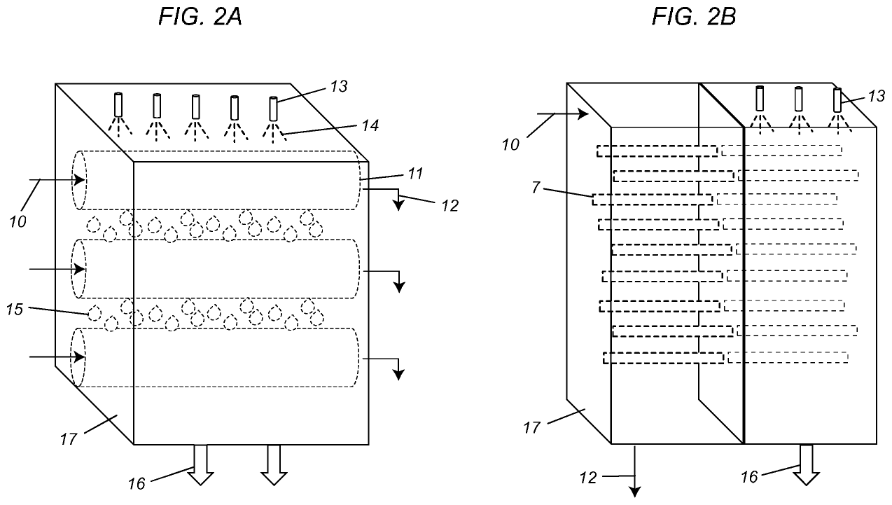

FIG. 2A illustrates a conventional stage in multiple effect distillation systems, and a similar configuration (FIG. 2B) using heat pipes. FIG. 2A shows a single MED stage (17) (called “effect”). In FIG. 2A a number of nozzles (13) spray a saline solution (14) over horizontal tubes (11) filled with low temperature steam (10) that comes from a previous effect at slightly higher temperature. As the steam (10) travels though the horizontal tube (11) it can condense into a liquid product (12) and the heat of condensation can be used to evaporate more of the saline solution (14) being sprayed from the top. As the saline solution evaporates, it can absorb the heat from the outer surface of the horizontal tube, thus can increase the salinity of the droplets (15) that fall from one horizontal tube to the next, and thus can increase also the salinity of the solution (16) that is subsequently fed to the next effect.

The horizontal tube effectiveness in lower parts of the bundle can be impacted by the thin film arriving from above, as illustrated in FIG. 2A. The upper tubes can be in the very effective droplet modes and the lower tubes can be in the much less efficient sheet mode. Because steam condensation occurs along the entire length of the tube bundle, there can be significant thermal resistance inside the tube bundle (due to pooling) as well as temperature loss along the tube bundle length. In addition, fouling is known to occur in horizontal thin-film evaporators as a result of hot spots that form on the outside surface of the tube bundle. Also, non-condensable gases (NCG) can be a problem in many condensation processes. Because conventional distillation systems operate under partial vacuum, non-condensable gases (e.g., nitrogen, oxygen) that evolve can significantly reduce thermal transfer in a horizontal thin-film condenser, simply because the gases collect on the condensing surfaces and the thermal conductivity of those gases can be rather poor, blocking the heat transfer.

Few, if any, of the above problems are encountered if the horizontal thin-film tubes of an MED are replaced by heat pipes, as illustrated in FIG. 2B. In FIG. 2B, steam (10) from a previous effect enters the distillation stage (17), and condenses on heat pipes (7), thereby transferring the heat of condensation to those heat pipes. The condensed liquid (12) can collect at the bottom of the stage (17), while the heat pipes can rapidly transfer the heat to the adjacent vessel where evaporation takes place. In the evaporation side, the spray nozzles (13) can shower the heat pipes with saline solution, which can partially evaporate, and the concentrated saline solution (16) can exit at the bottom, while the generated steam can transfer to the next effect. A clear advantage of this type of configuration rests with the superior heat transfer of heat pipes, which can require significantly less volume for condensation than a conventional MED stage. Similarly, the evaporation side can also require less volume, thus leading to savings in materials and a smaller footprint. These superior heat transfer properties of heat pipes can be similarly utilized in other thermal distillation systems, such as MSF (multi-stage flash) distillation, or VC (vapor compression) systems.

There can be barriers to heat transfer in both heat pipes and conventional thin-film heat exchangers. One of the most important barriers is the thermal resistance at the interface between the heat pipe surface layer and the evaporator chamber fluid phase, which is commonly known as the “double layer.” This double layer is composed of molecules that are more concentrated and ordered than in the bulk of the fluid phase, and results from a combination of electrostatic forces and ionic concentration. Consequently, the strength of this barrier decreases with salinity. Conventional thin-film heat exchangers can be limited in their ability to operate at high salinities because of fouling and hot spots, while heat pipes can operate at salinities exceeding 200,000 parts per million because of nucleate pool boiling. Thus, for salinity ranges and concentration ratios normally encountered in industrial practice, this barrier can become fairly minor when using heat pipes but remains significant for thin-film heat exchangers.

Heat pipes can be manufactured in sizes from microns to meters while being tailored to meet the heat transfer requirements. There are examples of thermosyphons in the range of 2 cm and up to 100 meters long. For example, thermosyphones can be about 2 cm, 50 cm, 100 cm, 500 cm, 750 cm, 1 meter, 25 meters, 50 meters, 75 meters or 100 meters. The ability to remove or add heat pipes to an operational exchanger allows the system to be fine-tuned to ensure optimum heat recovery. Similarly, pulsating heat pipes are designed for long-distance heat transfer, in the range of a few meters and up to thousands of meters; they normally operate without internal wicks and have optional internal valves that ensure flow in only one direction. The heat pipes can be about 2, 10, 50, 100, 200, 250, 500, 750, 1000, 2000, 3000, 4000, 5000 meters or more. Advanced heat pipes can include centrally located axial wicks, ultra-thin metallic foils (with wall thickness below 1 mm) that can optimize heat transfer and that can be wrapped around metal screens for structural strength. Metal screens can be chemically compatible with the working fluid, and the metals for such screens can include copper, steel, titanium, and other base metals and their alloys, or the like. These features are entirely unique to heat pipe recovery units.

Having no moving mechanical parts in a heat pipe yields a device that has exceptionally high reliability. There are many reliable material and fluid combinations that can be used without fouling or degradation over time; such as copper/water heat pipes. This is one of the most common combinations, as are aluminum/ammonia and ammonia/steel. Each individual heat pipe can operate independently, hence a single pipe failure will not incapacitate the system. Failed heat pipes can be replaced at the next scheduled maintenance event. The independent operation of a heat pipe system also can mean zero cross contamination between the pipes.

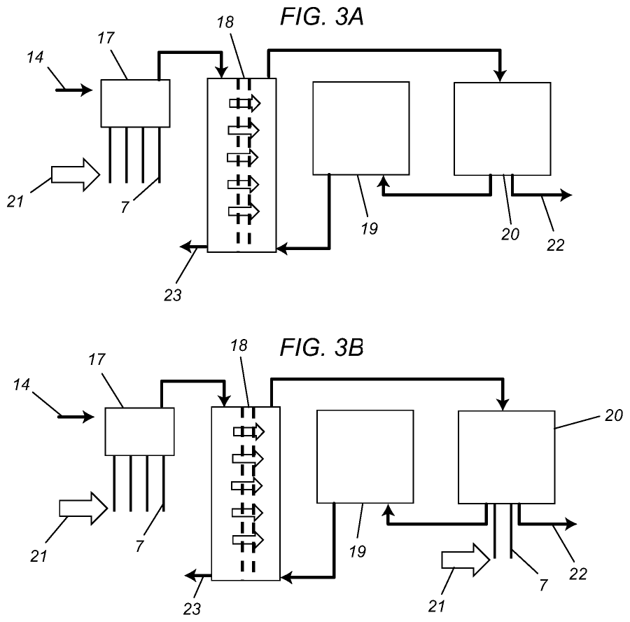

FIGS. 3A-3B illustrate a generic forward-osmosis system. In forward osmosis, a saline solution (14) is contacted across a semi-permeable membrane (18) with another solution containing significantly higher levels of salinity, and normally made by adding a soluble salt (solute) that can be relatively easy to separate and recover for reuse. The osmosis pressure across the membrane can make water migrate across the membrane toward the higher salinity solution, thus diluting the solute solution while concentrating the original saline solution. The dilute solute solution can be subsequently treated by either precipitation or distillation to recover the original solute, thus recovering the solute salt for reuse, while separating a relatively clean water product (22).

Heat can be used in forward osmosis in two separate ways. First, the osmosis rate of diffusion across the semi-permeable membrane can accelerate with temperatures higher than ambient. Second, distillation and some forms of precipitation require heat and, therefore, being able to use low-temperature forms of heat energy can become a significant economic advantage. The key concept here is the ability to use heat pipes in configurations similar to those illustrated in FIGS. 1A through 1E, or those similar to FIG. 2B in order to increase the operating temperatures of forward osmosis. In FIG. 3A, saline water enters a pre-heating vessel (17) where heat pipes (7) provide heat from a heat source (21). The heat source can include steam, combustion gases, solar energy, geothermal energy, or any form of waste heat. Once heated, the saline solution can enter a forward osmosis membrane (18) where osmosis transfers water into a more concentrated saline solution normally called “draw solution (19), thus diluting said draw solution.” Exiting the forward osmosis vessel (18), the dilute draw solution can flow into a draw solution recovery system (20), where product water (22) and draw solution (19) can be separated and recovered. The draw solution can flow into the draw solution vessel (19) and from there into the forward osmosis system (18), thus completing the cycle.

FIG. 3B illustrates a similar configuration wherein heat pipes (7) are also used to provide heat energy for separating the draw solution (19) from the product water. As previously indicated, the heat source can include steam, combustion gases, solar energy, geothermal energy, or any form of waste heat.

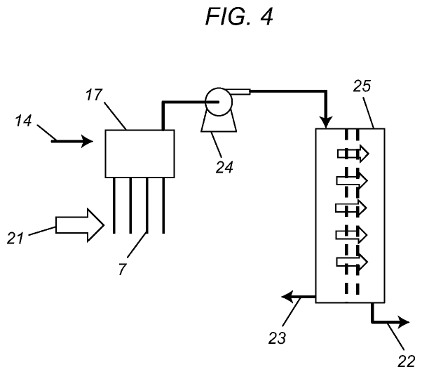

FIG. 4 illustrates a reverse osmosis system in which pre-treated saline water (14) is pressurized prior to entering an array of RO modules (of which only one module is shown). Again, as in the case of forward osmosis, the efficiency of an RO system improves when the saline solution is at temperatures higher than ambient. For this purpose, the ability to use heat pipes (7) in configurations similar to those illustrated in FIGS. 1A through 1E, or those similar to FIG. 2B in order to increase the operating temperatures of reverse osmosis can be a key advantage. In FIG. 4, saline water enters a pre-heating vessel (17) in which heat pipes (7) transfer heat from a broad range of heat sources, such as steam, combustion gases, geothermal, solar, or various sources of waste heat. Once heated, the saline solution is pressurized with a high-pressure pump (24) prior to entering a reverse osmosis membrane (25) where water can permeate across the membrane, thus yielding product water (22) and a heavy waste brine (23).

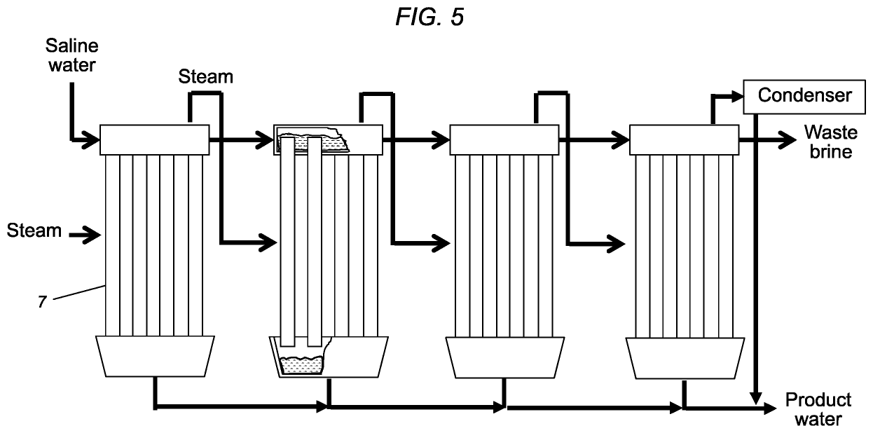

FIG. 5 illustrates an MED system in a vertical configuration. As is the case of a horizontal configuration, the individual effects can be replaced by a smaller volume of condensers and evaporator vessels, similar to the configuration of FIG. 2, but with a vertical arrangement.

The invention illustratively described herein suitably can be practiced in the absence of any element or elements, limitation or limitations which are not specifically disclosed herein. The terms and expressions which have been employed are used as terms of description and not of limitation, and there is no intention that in the use of such terms and expressions indicates the exclusion of equivalents of the features shown and described or portions thereof. It is recognized that various modifications are possible within the scope of the invention disclosed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the disclosure.

Those skilled in the art recognize that the aspects and embodiments of the invention set forth herein can be practiced separate from each other or in conjunction with each other. Therefore, combinations of separate embodiments are within the scope of the invention as disclosed herein.

All patents and publications are herein incorporated by reference to the same extent as if each individual publication was specifically and individually indicated to be incorporated by reference.

What is claimed is:

1. A system, comprising:
a first heat source;
a heating vessel containing a saline solution having a first salinity;
a first plurality of heat pipes, wherein a first portion of each heat pipe is in thermal communication with the first heat source and a second portion of each heat pipe is in thermal communication with the saline solution in the heating vessel;
a forward osmosis vessel containing a semipermeable membrane;
a draw solution vessel containing a draw solution having a second salinity, wherein the second salinity is higher than the first salinity; and
a draw solution recovery system.

2. The system of claim 1 wherein the system is configured to heat the saline solution in the heating vessel to form a heated saline solution, to receive the heated saline solution in the forward osmosis vessel where water is removed from the heated saline solution and combined with the draw solution to form a dilute draw solution, to receive the diluted draw solution into the draw solution recovery system where water is removed from the diluted draw solution to recover the draw solution, and to receive the draw solution into the draw solution vessel.

3. The system of claim 2, further comprising a second plurality of heat pipes, wherein a first portion of each heat pipe is in thermal communication with a second heat source, and a second portion of each heat pipe is in thermal communication with the draw solution recovery system.

4. The system of claim 3 wherein the second plurality of heat pipes is configured to heat the diluted draw solution in the draw solution recovery system.

5. The system of claim 1 wherein the first plurality of heat pipes is selected from the group consisting of advanced heat pipes, and thermosiphons.

6. A Multi-Effect Distillation (MED) system, comprising:
a condensation vessel, the condensation vessel comprising an inlet configured to allow steam to enter the condensation vessel;
an evaporation vessel adjacent to the condensation vessel;
a plurality of heat pipes, wherein each heat pipe comprises a first portion within the condensation vessel and a second portion within the evaporation vessel; and
a plurality of spray nozzles configured to spray a saline solution into the evaporation vessel and onto the second portion of the heat pipes.

7. The system of claim 6 wherein each heat pipe is selected from the group consisting of advanced heat pipes, and thermosiphons.
